(19) United States
(12) Patent Application Publication
(10) Pub. No.: US 2006/0210874 A1
(43) Pub. Date: Sep. 21, 2006

(54) Electrode for an electrochemical cell, electrode coil, electrochemical cell, and production method

(76) Inventors: Werner Erhardt, Ballendorf (DE); Andree Schwake, Heidenheim (DE)

Correspondence Address: FISH & RICHARDSON PC, P.O. BOX 1022, MINNEAPOLIS, MN, 55440-1022, US

(21) Appl. No.: 10/542,712

(22) PCT Filed: Dec. 23, 2003
(86) PCT No.: PCT/DE03/04288

§ 371 Date: Mar. 14, 2006

(30) Foreign Application Priority Data
Jan. 21, 2003 (DE) 103 02 119.1

(51) Int. Cl. H01M 4/02; B05D 5/12; H01M 4/58

(52) U.S. Cl. 429/209; 427/122; 429/231.8

(57) ABSTRACT

The present invention relates to an electrode (1) for an electrochemical cell having a liquid electrolyte (3), containing channels (2), into which an electrolyte liquid may flow. The electrode (1) has the advantage that the impregnation time of the electrochemical cell may be reduced.

The present invention relates to an electrode for an electrochemical cell which contains an electrolyte. Furthermore, the present invention relates to an electrode roll. In addition, the present invention relates to an electrochemical cell having the roll.

Electrochemical cells are known, for example, in the form of electrochemical double-layer capacitors from the publication DE 100 60 653 A1. The electrochemical double-layer capacitors described therein have the form of electrode layers produced from activated carbon, which are contacted with supply line layers, such as an aluminum film, for example. To manufacture the electrochemical double-layer capacitor, a stack of electrodes lying one on top of another having continuously alternating polarity must be installed in a housing and impregnated there with a liquid electrolyte. To form the roll, either a large number of individual electrodes are stacked one on top of another or two electrodes of different polarity are wound up along a longitudinal direction. In both cases, the electrodes of different polarity are electrically separated from one another by a separator.

The known electrodes have the disadvantage that the process of impregnation takes up a very long time, since it takes a very long time until the electrolyte liquid has penetrated into the separator positioned between electrodes and displaced the air stored there. For example, in a roll for a capacitor having a capacitance of 5000 F, which comprises approximately 6.5 m anode film and 6.5 m cathode film and a corresponding quantity of separator lying between them, a time of approximately 72 hours is necessary until the roll is completely impregnated by the electrolyte liquid and all of the gas from the pores of the activated carbon of the electrodes and the separator has escaped from the capacitor through the impregnation opening.

In addition, the problem exists that in the event of incomplete exchange of gas for electrolyte, under some circumstances, the outgassing will still be continued even after the capacitor is closed, which leads to bursting of the capacitor in extreme cases.

To shorten the impregnating time, impregnating a roll with an electrolyte under partial vacuum is additionally known from the publication JP 11339770-A. However, this method has the disadvantage that the problem of impregnation time is only inadequately solved and, in addition, an increased outlay in apparatus is required for impregnating the roll.

It is therefore the object of the present invention to specify an electrode for an electrochemical cell which allows rapid impregnation.

This object is achieved by an electrode according to Claim 1. Advantageous embodiments of the electrode, a roll made of the electrode, and an electrochemical cell may be inferred from the further claims.

The present invention is based on the idea that by providing channels in the electrode, the exchange of electrolyte for gas may occur more rapidly, since such channels are suitable for the purpose of rapidly transporting small gas quantities and/or gas bubbles to the outside even from the interior of the roll and/or providing the electrolyte in a sufficient quantity through these channels even in the interior of the capacitor, so that the impregnation may occur more rapidly than if the electrolyte may be offered in a sufficient quantity solely from the two front faces of the roll.

Accordingly, an electrode for an electrochemical cell having an electrolyte is specified, which contains channels into which an electrolyte liquid may flow.

The electrode has the advantage that the exchange of electrolyte liquid and gas in a roll may occur more rapidly during the impregnation through the channels.

In one embodiment of the electrode, the channels may be implemented in the form of grooves on the surface of the electrode. This has the advantage that the manufacturing of the channels may be greatly simplified, since the electrodes may be manufactured in a first method step and the grooves may be introduced externally into the electrodes through subsequent processing, through embossing, for example, in a second method step.

In one embodiment of the electrode, it has a coated film, the grooves being formed by uncoated partial regions of the film. Such an electrode has the advantage that the grooves may be produced simultaneously with the manufacturing of electrode, which may noticeably reduce the time for manufacturing the electrode. Furthermore, such an electrode has the advantage that the depth of the grooves is automatically predefined by the thickness of the coating.

In addition, it is advantageous if the channels have a width between 0.1 and 0.5 mm. It is thus simultaneously ensured that the channels do not fall below a certain minimum width, which would make the transport of the electrolyte liquid more difficult. In addition, simultaneously, too much volume of the electrode is not lost by producing the channels, which would have negative effects on the capacitance of the electrochemical double-layer capacitor used as an electrochemical cell, for example.

It is to be noted at this point that all devices in which any type of electrical effect is to be achieved through an electrode and through the presence of a liquid electrolyte are to be understood under the concept “electrochemical cell”. For example, aluminum-electrolyte capacitors, electrochemical double-layer capacitors, or even batteries come into consideration here.

Furthermore, it is advantageous if the depth of the channels is between 50 and 100 μm. This dimension has the advantage that it corresponds to the thickness typically selected for the coating, through which simple implementation of the channels as grooves in the coating is possible.

In addition, it is advantageous if the electrode extends along a longitudinal direction, the channels running transversely to the longitudinal direction. Such an electrode has the advantage that it may be wound up in the longitudinal direction into a rolled coil, the electrolyte liquid being able to penetrate along the channels into the interior of the roll from the front faces of the roll through the arrangement of the channels transverse to the longitudinal direction.

In this case, the channels may advantageously run essentially along equidistant straight lines which are parallel to one another. In this way, the manufacturing of the channels is simplified. For example, transverse grooves spaced equidistantly from one another may be produced using embossing, a roller being used which has a linear projection running parallel to the axis of rotation of the roller.

In another embodiment of the electrode, the channels may run diagonally to the longitudinal direction of the electrode. This embodiment has advantages in turn in regard to the manufacturing of the channels. Specifically, in contrast to the manufacturing described above, it is no longer necessary to provide a projection running parallel to the axis of rotation of the roller, which results in discontinuous mechanical impacts of the axis carrying the roller as it rolls on the electrode. This mechanical impact results because each time that the projection presses the electrode against a buttress in order to produce an embossing in the electrode, a corresponding discontinuous force acts on the roller.

In another embodiment, the channels may run along curved lines which are offset parallel to one another.

Such an embodiment of the electrode has the advantage that the manufacturing may again be performed using a roller provided with one or more embossings.

In another embodiment, the channels cross over one another. It is thus possible to integrate the channels into the electrode along two different preferred directions which enclose an angle of 90° to one another, for example.

Furthermore, it is especially advantageous for specific electrochemical cells such as EDLC or lithium-ion batteries if the electrode contains a metal film coated with carbon powder. For example, an aluminum film comes into consideration as the metal film.

In addition, an electrode roll is specified in which multiple layers of one of the electrodes just described are positioned one on top of another. Such an electrode roll has the advantage that it may be used as a capacitor roll in a double-layer electrolytic capacitor.

It is to be noted here that to achieve a high volume utilization during the manufacturing of the roll, it is regularly ensured that the roll is constructed very compactly. This compactness of the roll makes it more difficult for the electrolyte to penetrate into the interior of the roll. This means that precisely in very compact rolls, in which either electrode layers lying one on top of another are provided in the form of a stack, the stack being pressed together, or even with a very tightly rolled coil, the channels may advantageously be used.

Correspondingly, a roll in which two electrodes of different polarity are wound up is advantageous.

In addition, an electrochemical cell is also specified which contains a liquid electrolyte and which additionally contains one of the rolls described above. Such an electrochemical cell has the advantage that the impregnation of the roll with the liquid electrolyte may occur very rapidly.

Correspondingly, an electrode for an electrochemical double-layer capacitor having a liquid electrolyte is specified which contains a metal film coated with activated carbon powder. Channels are provided in the carbon coating, into which an electrolyte liquid may flow and which are used for improving the exchange between electrolyte liquid and gas contained in the pores of the carbon coating.

Furthermore, the present invention relates to a method for manufacturing the above-mentioned electrode. The grooves and channels according to the present invention may be obtained with the aid of the following methods, for example:
a) Calendering of coated and not yet embossed electrodes at elevated temperature. This process may also be integrated into the winding process;
b) Coating an already embossed metal film (e.g., an aluminum film) with activated carbon;
c) Scratching of grooves and channels into the activated carbon coating of an untreated electrode, e.g., with the aid of a swinging tip, while simultaneously suctioning off the scratched-off coating;
d) Covering the regions of an unembossed metal film provided for producing grooves and/or channels in the form of a regular pattern during the coating of the metal film with the activated carbon, through which uncoated regions of the electrodes arise that function as channels according to the present invention.

In the following, the present invention will be explained in greater detail on the basis of exemplary embodiments and the associated figures:

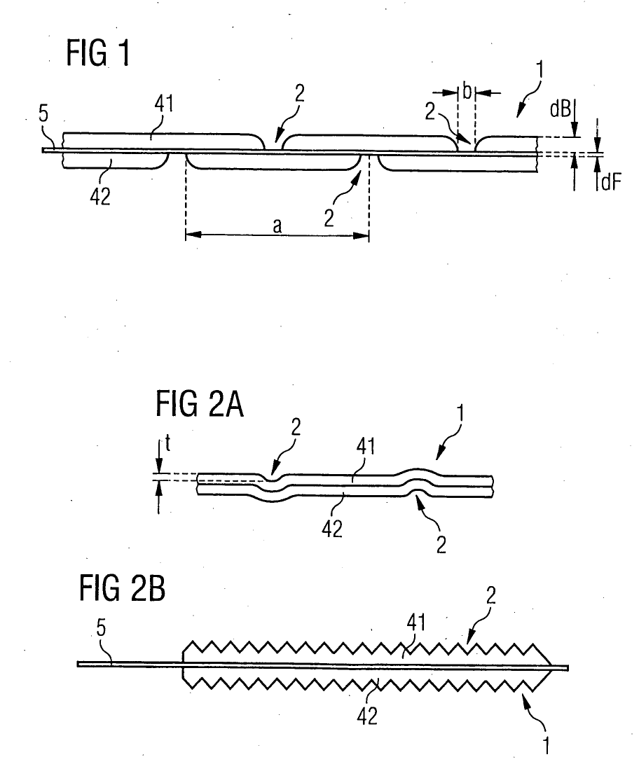

FIG. 1 shows an electrode in a schematic longitudinal section as an example.

FIGS. 2A, 2B show further electrodes in a schematic longitudinal section as an example.

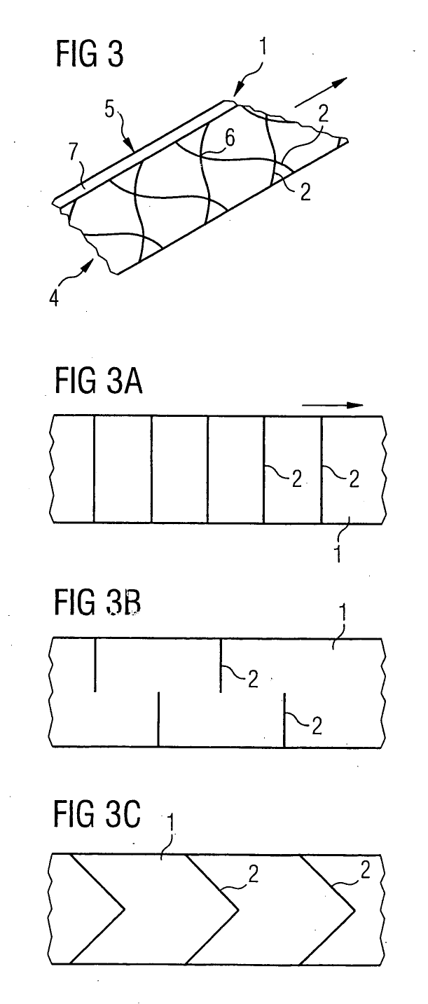

FIG. 3 shows an electrode in a top view as an example.

FIGS. 3A, 3E, 3C show a further electrode in a top view as an example.

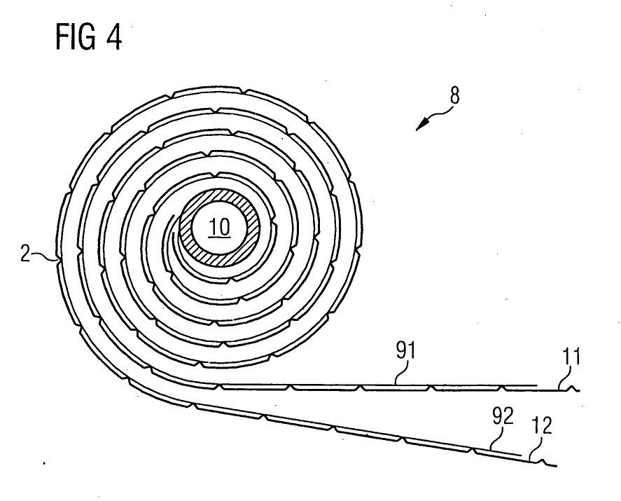

FIG. 4 shows a roll in a schematic cross-section.

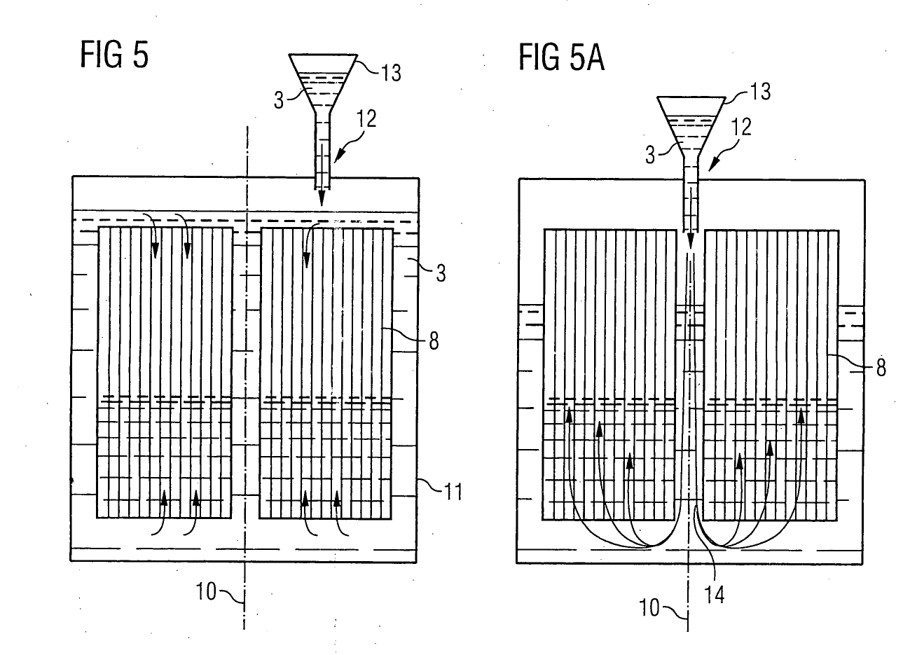

FIG. 5 shows an electrochemical cell in a schematic cross-section.

FIG. 5A shows a further electrochemical cell in a schematic cross-section.

It is to be noted here that identical reference numbers are assigned to either identical elements or elements having identical or similar functions in the figures.

FIG. 1 shows an electrode 1, which comprises a film 5 that is coated on the top and on the bottom with a coating 41, 42 in each case. The film 5 is an aluminum film, the thickness of the film dF being between 10 and 100 μm.

Typically, a dimension between 30 and 300 μm is selected for the thickness dB of the coating 41, 42. The coating is, for example, an activated carbon powder which has been applied to the electrode through powder coating. The mean diameter of the activated carbon particles is in the range from 0.2-5 μm, for example. The density of the electrodes is approximately 0.6 to 0.8 g/cm³. The porosity of the electrodes is approximately 35 to 65%. The capacitance density is approximately 10 to 25 F/cm³.

Channels 2 are provided in both the upper and the lower coatings 41, 42. The channels 2 are formed by interruptions of the coating of the film 5. In this case, the channels 2 have the shape of grooves. They may also be viewed as depressions of the coatings 41, 42, i.e., it is not necessary for the coatings 41, 42 to be completely interrupted at the locations of the channels 2, rather, it would also suffice if the coatings 41, 42 were merely thinner at the locations of the channels 2 than at the remaining regions.

The width b of the channels 2 is between 0.1 and 1 mm. These dimensions are merely to be considered advantageous dimensions in this case. Other widths may thus also be selected for the channels 2. The distance a between two channels on the same side of the film 5 is advantageously selected as between 30 and 100 mm. In order to distribute the channels 2 uniformly in the roll to be produced from the electrode 1, it is advantageous if the channels 2 on the top are positioned offset in relation to the channels 2 on the bottom of the film 5.

In addition to producing the channels 2 by interrupting the coating 4, it is also possible to manufacture the channels 2 through material removal.

FIG. 2A shows an electrode 1 in which the channels 2 are produced through embossing in the electrode 1. It may particularly be seen here that the depth t of the channels 2 may be set variably i.e., it is not restricted to the thickness of the coating as in the example shown in FIG. 1, reference particularly being made to channels 2 that are manufactured through interruptions of the coating 4. Rather, the depth t may take many different values. The depth t is advantageously between 10 and 200 μm.

The channels 2 manufactured through embossing according to FIG. 2 additionally have the advantage that a protrusion of the film arises on the side of the film diametrically opposite the channel 2, which later ensures additional spaces between the electrode layers lying one on top of another when the electrode is later wound up into a roll, and therefore produces further channels for the transport of the electrolyte liquid.

FIG. 2B shows the electrode 1 in which the channels 2 are again produced through embossing as shown in FIG. 2A, however, no notable interval is still provided between the channels 2 here, but rather they lie directly neighboring one another. The density of the channels may thus be elevated to a maximum, through which the duration of the impregnation may be shortened to a minimum time.

FIG. 3 shows an electrode 1 which runs along a longitudinal direction (indicated by the arrow). The electrode comprises an aluminum film 5 which is partially provided with a coating 4. On the left edge, the film 5 has a free edge 7, which allows the roll to be connected by contacting the free edge with an external terminal of the electrochemical cell. It may be seen from FIG. 3 that the channels 2 run along curved lines which may be offset parallel to one another, for example. It may also be seen from FIG. 3 that the channels 2 cross over one another and thus form intersection points 6.

The electrode shown in FIG. 3 has the advantage that the channels 2 may be distributed very well homogeneously over the area of the electrode and accordingly homogeneously over the volume of the roll later in the completed roll. In addition, the manufacturing may be performed using a roller through embossing, a discontinuity during rolling of the roller able to be largely avoided through projections running along the circumference of the roller.

FIGS. 3A, 3B, and 3C show further possibilities for positioning the channels 2. The electrode 1 again runs in a longitudinal direction (indicated by the arrow) and is therefore especially suitable for manufacturing a roll as shown in FIG. 4. In FIG. 3A, the channels 2 are positioned along equidistant linear sections running parallel to one another. Such channels 2 may be produced through scratching into the coating 4, for example.

As shown in FIG. 3B, the channels 2 are positioned along straight lines running parallel to one another. In this case, each channel 2 originates from an edge delimitation of the electrode 1 and runs from there toward the inside, but without reaching the diametrically opposite edge. The channels 2 each alternately originate from the upper and/or the lower delimitation edge of the electrode 1. Through such a design of the channels 2, the flow of the electrolyte from the top and the bottom of the electrodes may be encouraged spatially offset from one another.

As shown in FIG. 3C, the channels 2 are positioned as linear parts, which form an approximately right angle along a center line of the electrode 1. An equalization of the impregnation over the roll formed by stacking or winding electrodes 1 may thus be achieved. In particular, the spacing between the channels 2 may be reduced in such a way that there is no longitudinal section of the electrode 1 without a channel 2.

FIG. 4 shows a roll 8, which is formed from two electrodes 11, 12 and two separators 91, 92. The separators 91, 92 have the object of absorbing the liquid electrolyte, which is essential for the functioning of the electrochemical cell. In addition, the separators 91, 92 have the object of avoiding a short-circuit between directly diametrically opposing electrodes 11, 12 of different polarity. For example, paper or even a porous plastic is used as the separators 91, 92. If paper is used, the separators 91, 92 are preferably implemented as double-layered, in order to prevent the danger of the occurrence of pores running through the entire thickness of the separator 91, 92 in one ply, which could cause a short-circuit. The thickness dS of the separator 91, 92 is typically between 10 and 100 μm. The package made of electrodes 11, 12 and separators 91, 92 is wound around the roll axis 10 into a roll 8. The channels 2 of the electrodes 1 are then provided uniformly distributed in the completed roll 8.

The layer thickness ratios in FIG. 4 also show why it is advantageous to incorporate the channels into the coating of the film. Specifically, the coating of the film has the greatest thickness in the layer package, because of which the largest channels may also be produced here.

The larger the channels are, the better the exchange between liquid electrolyte and gas in the roll functions.

Furthermore, it is advantageous if, in addition to the electrode, the separator 9 is also provided with channels to improve the impregnation.

FIG. 5 shows the procedure of the impregnation, a roll 8 as shown in FIG. 4 being installed in a cylindrical housing 11. The axis of symmetry of the housing 11 and the roll axis 10 are congruent. A fill opening 12 is provided on the top of the housing 11, liquid electrolyte 3 being able to be poured into the housing using a funnel 13. The curved arrows show the flow direction of the electrolyte 3 within the channels in the roll 8. In a comparison test, in which a roll as shown in FIG. 4 without channels and a roll as shown in FIG. 4 in connection with FIG. 3A, where channels were provided at approximately 5 cm distance to one another, were impregnated with the same electrolyte, a shortening of the impregnation time by at least a factor of 60 could be determined. The channels may also be spaced by approximately 4 to 6 cm or by approximately 1 to 10 cm from one another. In order that the electrical and mechanical properties of the electrodes are not impaired, the distance between the channels is preferably greater than 0.1 cm. In order to achieve the improvement of the impregnation properties, the distance between the channels is preferably less than 30 cm. The distance between the channels is preferably between 0.5 and 25 cm.

FIG. 5A shows an impregnation device similar to that in FIG. 5, the fill opening 12 being positioned directly above the core tube 14 of the roll 8, however, and the impregnation correspondingly being performed from the bottom of the roll 8, as indicated by the curved arrows.

It is also to be noted here that 0.5 M to 1.6 M tetraethyl ammonium tetrafluoroborate in acetonitrile is preferably provided as the electrolyte for the electrochemical double-layer capacitor described in these examples.

The greater the viscosity of the electrolyte, the more channels or wider channels are necessary.

The present invention is not restricted to electrochemical double-layer capacitors and to electrodes having aluminum film and carbon coating, but rather may be applied in all electrodes for all conceivable electrochemical cells which contain a liquid electrolyte.

### LIST OF REFERENCE NUMBERS

1, 11, 12 electrode
2 channel
3 electrolyte
41, 42 coating
5 film
6 intersection point
7 free edge
8 roll
91, 92 separator
10 roll axis
11 housing
12 fill opening
13 funnel
14 core hole
dB thickness of the coating
dF thickness of the film
dS thickness of the separator
b width of the channel
t depth of the channel
a spacing of two channels

1. An electrode for use with an electrochemical cell having a liquid electrolyte, the electrode comprising:
channels that are capable of holding the liquid electrolyte.

2. The electrode of claim 1, further comprising a film that defines the channels.

3. The electrode of claim 1, wherein the channels comprise grooves on a surface of the electrode.

4. The electrode of claim 1, wherein the channels are embossed into the electrode.

5. The electrode of claim 1, further comprising:
film on a surface of the electrode;
wherein the channels comprise regions of the electrode that are not covered by the film.

6. The electrode of claim 1, wherein at least one of the channels has a width between 0.1 mm and 1 mm.

7. The electrode of claim 1, wherein at least one of the channels has a depth between 10 μm and 200 μm.

8. The electrode of claim 1, wherein the electrode extends along a longitudinal direction and wherein the channels run transversely to the longitudinal direction.

9. The electrode of claim 1, wherein the channels comprise substantially straight lines that are substantially parallel to one another and that have substantially same lengths.

10. The electrode of claim 1, wherein the electrode extends along a longitudinal direction and wherein the channels run substantially diagonal to the longitudinal direction.

11. The electrode of claim 1, wherein the channels are curved and substantially parallel to one another.

12. The electrode of claim 1, wherein at least two of the channels intersect.

13. The electrode of claim 1, wherein the electrode comprises a metal film coated with carbon powder.

14. An electrode roll comprising:
multiple layers of electrodes positioned one on top of another;
wherein at least one of the multiple layers comprises channels that are capable of holding liquid electrolyte.

15. The electrode roll of claim 14, wherein the multiple layers of electrodes comprise two electrodes wound together.

16. An electrochemical cell comprising:
a liquid electrolyte; and
multiple layers of electrodes positioned one on ton of another;
wherein at least one of the multiple layers comprises channels that hold the liquid electrolyte.

17. A method of manufacturing the electrode of claim 1, comprising:
coating the electrode with a film;
calendereing the electrode coated with the film at a temperature that exceeds a predefined temperature; and
embossing the electrode following calendering to form the channels.

18. The method of claim 17, wherein calendering is part of a winding process for manufacturing an electrode roll using the electrode.

19. A method of manufacturing the electrode of claim 1, comprising:
embossing the electrode;
coating at least part of the electrode with activated carbon; and
calendereing the electrode.

20. A method of manufacturing the electrode of claim 1, comprising:
coating an unembossed metal film with an activated carbon; and
forming the channels in the activated carbon while suctioning off coating.

21. The method of claim 20, wherein forming comprises etching the channels in the activated carbon using a swinging tip.

22. A method of manufacturing the electrode of claim 1, comprising:
covering regions of an unembossed metal film designated for the channels while coating the unembossed metal film with activated carbon.
